(19) United States
(12) Patent Application Publication
(10) Pub. No.: US 2019/0370753 A1
(43) Pub. Date: Dec. 5, 2019

(54) Intelligent Timesheet

(71) Applicant: SAP SE, Walldorf (DE)

(72) Inventors: Melvi Pais, Heidelberg (DE); Shruthi Amblur Ramesh Babu, Heidelberg (DE)

(21) Appl. No.: 15/996,081

(22) Filed: Jun. 1, 2018

(51) Int. Cl. G06Q 10/10; G06N 5/02

(52) U.S. Cl. CPC G06Q 10/1091; G06N 5/02

(57) ABSTRACT

Methods, systems, and computer-programmable products are described herein for generating intelligent timesheets. An interactive message conversation is initiated with a user. A first message of the interactive message conversation is received. The first message including timesheet data associated with a task performed by the user. A time element having qualitative information about the task from the timesheet data is extracted. A knowledge base is queried for data associated with the time element. A second message responsive to the first message is generated based on the data. The second message is provided to the user as part of the interactive message conversation.

### TECHNICAL FIELD

The subject matter described herein relates to techniques for electronic timesheets.

### BACKGROUND

Timesheets are one of the most widely used methods for recording an amount of time a worker has spent on a job. Depending upon time entry requirements, timesheets can range from time entry of an amount of time spent in the office, on a particular project, or on a particular task. Some timesheets can be equipped with an integrated timer or entry boxes which record a start time and end time for a task. Other timesheets can record a total time increment duration (e.g., hours, minutes, seconds). Timesheets primarily reflect quantitative data for various accounting functions such as employee pay and/or client billing calculations.

### SUMMARY

In one aspect, an interactive message conversation is initiated with a user. A first message of the interactive message conversation is received. The first message includes timesheet data associated with a task performed by the user. A time element having qualitative information about the task from the timesheet data is extracted. In some variations, the time element can be extracted using at least one of natural language processing or speech recognition. A knowledge base is queried for data associated with the time element. A second message is generated responsive to the first message based on the data. The knowledge base can include at least one of a project work-breakdown structure (WBS), a maintenance order, an internal order, a service order, a timesheet calendar, a timesheet configuration, or predetermined questions and answers. The second message is provided to the user as part of the interactive message conversation.

In some variations, the interactive message conversation can be initiated by the user. In other variations, the interactive message conversation can be initiated by the machine learning model based on a periodic-based message at a predetermined frequency. Alternatively, the interactive message conversation can be initiated by the machine learning model based on an event-based message triggered by at least one of user availability determined by a calendar of the user, a termination of the task, or a time duration of the task, or termination of efforts of the user on the task.

In other variations, a category corresponding to the time element can be identified. At least one of a timesheet with the extracted time element or a report can be generated with the identified category.

In some variations, the timesheet data can be correlated with an external data source. The external data source can include at least one of a calendar application, a text document, or a database. The database can be an in-memory database.

In other variations, the timesheet data can be provided via input to an application displayed on an electronic device. The input can be at least one of verbal input or textual input.

In some variations, based on the absence of an identified category, a new category can be generated corresponding to an unidentified time element.

In other variations, a report including sentiment analysis can be generated based on the qualitative information.

In some variations, the time element can include quantitative information.

In other variations, content of the second message can be compared with a message configuration identifying required qualitative and/or quantitative information to confirm that the content is complete. Based on an incomplete second message, a third message can be generated based on a second query of the knowledge base.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, use of the subject matter herein can add a qualitative component to timesheets. Through the use of machine learning, speech, and/or language processing capabilities, timesheets can be populated with both quantitative and qualitative information, and submitted through verbal interaction between a time entrant and an electronic device.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating an example software architecture for use in connection with the current subject matter;

FIG. 2 is a block diagram illustrating components of an intelligent timesheet;

FIG. 3 is another block diagram illustrating an intelligent timesheet;

FIG. 4 illustrates an example flowchart depicting data processing associated with the intelligent timesheet;

FIG. 5 illustrates example flowchart depicting the pre-process operations of FIG. 4;

FIG. 6 illustrates an example process flow of execution operations;

FIG. 7 illustrates an example message via a user application for obtaining timesheet data from a user;

FIG. 8 illustrates an example interactive message conversation between the employee and an automated message response;

FIG. 9 illustrates another example interactive message conversation between the employee and an automated message response;

FIG. 10A illustrates another example interactive message conversation between the employee and an automated message response gathering qualitative information such as sentiments;

FIG. 10B illustrates another example interactive message conversation between the employee and an automated message response;

FIG. 11A illustrates another example interactive message conversation between the employee and an automated message response;

FIG. 11B illustrates an example follow-up conversation between the employee's manager and response machine learning model based upon the interactive message conversation of FIG. 11A;

FIG. 12 illustrates another example interactive message conversation between the employee and an automated message response;

FIG. 13 illustrates an example report having quantitative and qualitative information;

FIG. 14 is a process flow diagram illustrating an intelligent timesheet; and

FIG. 15 is a diagram illustrating a sample computing device architecture for implementing various aspects described herein.

Like reference symbols in the various drawings indicate like elements.

### DETAILED DESCRIPTION

Timesheets are one method used for recording an amount of time a worker has spent on a given task or job. Timesheets can come in a variety of formats and can range in the amount of information that is required. For example, timesheets can reflect a time duration an employee has been in the office on a particular day, in a particular week, or even a particular month. A timesheet can record time spent at the job or on a particular task. Time durations can be recorded in varying time increments (e.g., days, hours, minutes, seconds). Timesheet tools can be tailored to a particular time increment or time allocation entry based on business needs. As described in detail herein, timesheets can be generated through interaction with a machine learning model and the use of speech recognition and/or natural language processing. Various qualitative data relating to a user's timesheet (e.g., sentiment analysis) can be extracted from various user inputs (e.g., user calendar, prompted application user interactions).

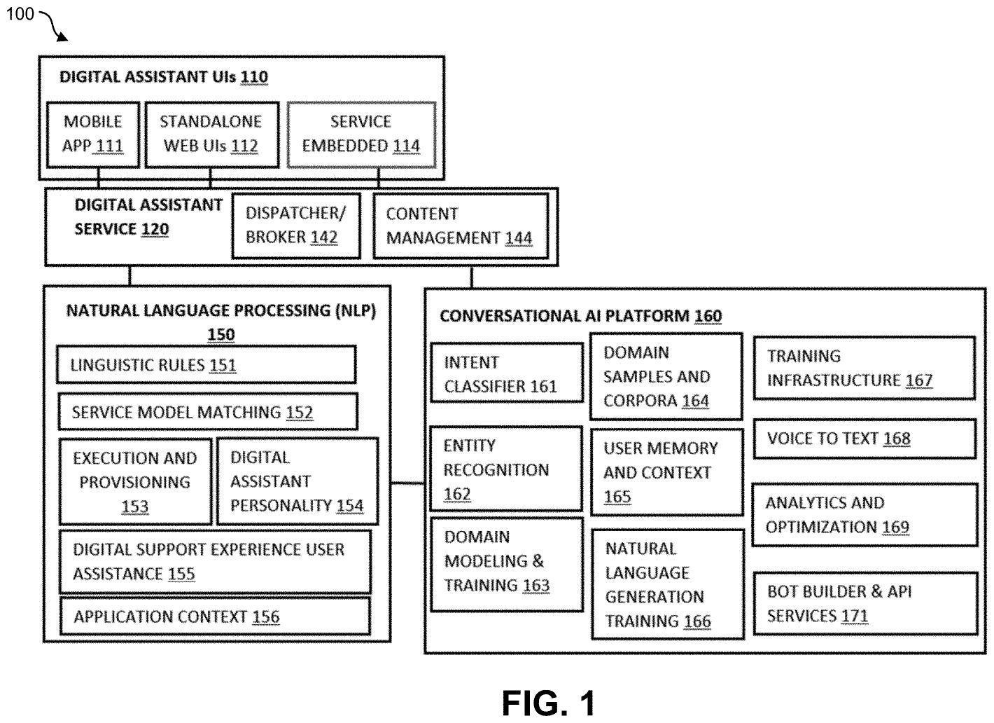

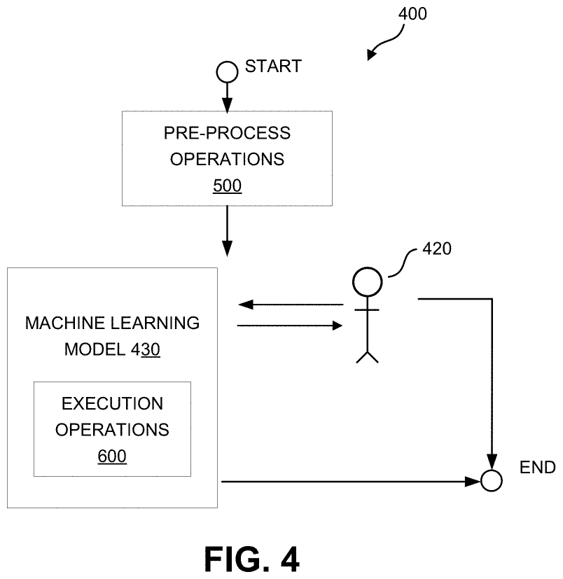

FIG. 1 is a diagram illustrating a software architecture 100 for use in connection with the current subject matter. One or more digital assistant user interfaces 110 can be displayed on messenger and/or voice enabled devices to facilitate an interactive message conversation with a user. The one or more digital assistant user interfaces can include, for example, an application (such as a mobile application 111), a standalone web-based user interface 112, and/or an embedded user interface (such as service embedded 114). As described in more detail below, a digital assistant UI can enable a user to interactively exchange messages facilitated by a machine learning model. The interactive message conversations can be triggered from a particular context or can be standalone initiated. A digital assistant service 120 can include a dispatcher/broker 142 and content management capabilities 144. Dispatcher/broker 142 can facilitate the sending and/or receiving of various messages within an interactive message conversation with a user. Content management capabilities 144, as described in more detail in FIGS. 4-6.

Natural language processing (NLP) 150 can be used to generate and/or process messages within an interactive message conversation. Words within each message can be analyzed through text recognition and extracted using various linguistic rules 151. NLP 150 can include service model matching 152 which matches a query of a database such an in-memory database or an externally coupled database and/or an enterprise search to extract relevant and/or matching entities. Application context 156 can provide context for various messages of an interactive message conversation. For example, the application context 156 can include related business objects which are entities that can be discovered about a particular message via a currently running application context, through a search, or via recent objects or text analysis. Digital support experience user assistance 155 can be used to enhance the presentation of the messages in digital assistant user interfaces 110.

Execution and provisioning 153 can perform natural language understanding (NLU) which can apply to a set of applications. Text of the interactive message conversation can using, for example, text Analysis (TA) where rules and/or lexica/dictionaries, grammar, and/or parsers can be used to enrich text with meta information (e.g., metadata). This metadata can be used with other algorithms to try to resolve the semantic meaning, and/or process an intent of the user (e.g., to create a new timesheet, obtain information on a task or project). Execution and provisioning 153 can also perform natural language generation (NLG) which is a framework that generates grammatically correct sentences based on pre-defined templates. The template sentences can contain place holders that are filled during runtime, allowing the NLG framework to be used without a deep understanding of linguistics and/or the need to follow or apply grammatical rules. For example, plurals, definitive/indefinite articles or personal pronouns can be calculated by the NLG framework depending on the place-filler content. NLG dialog flow can be used to generate prompts/utterances/messages for the digital assistant UIs 110 for various operations that are initiated by the user or decided by the system. For example, the NLG dialog flow can include operations such as create, read, update, delete (CRUD) business objects, named operations (such as “Create Leave Request”). NLG dialog flows can also support various elements such as software commands and/or conversational elements such as greetings or personalities (e.g., digital assistant personality 154).

A conversational artificial intelligence (AI) platform 160 complements NLP 150 with various components to analyze and generate various messages of an interactive message conversation. Voice to text 168 processing can generate text from voice interactions of a user with an electronic device. Analytics and optimization 169 can enable suitable responses to queries by deriving insights from the user interaction and narrowing the response from virtually innumerable possibilities. Various message content can be stored and/or retrieved with user memory and context 165. Training infrastructure 167 can facilitate automatic training of the bots with several examples on the intent and context 160. Domain samples and corpora 164 having samples annotated with linguistic properties can also be used for various model training 163 and NLG training 166. Intent classifier 161 can support NLP 150 to identify a user intent and entities from user utterance. A user intent can include, for example, information such as a service definition (e.g., Uniform Resource Identifier (URI), entity type), visualization cues for results (e.g., title, sub-title), properties, and/or synonyms. Intent classifier 161 can utilize utterance analysis to extract semantic information from a user's sentence (or utterance). The input of the analysis can be in the form of text, which can be either typed by the user into an electronic device or output from a speech-to-text recognition engine. Semantic information can be, for example, conversational elements such as intent, named entities, and/or discrete entities. Entity recognition 162 toolset can provide tooling and support for automated transformation of language files to text analysis dictionaries and/or rules. Additionally, entity recognition 162 toolset can provide support for adding entity names such as semantic objects to extent recognition of additional entities. Conversational AI platform 160 can also include BOT builder & application programming interface (API) services 171 for the generation of bots and to handle interactive message conversation.

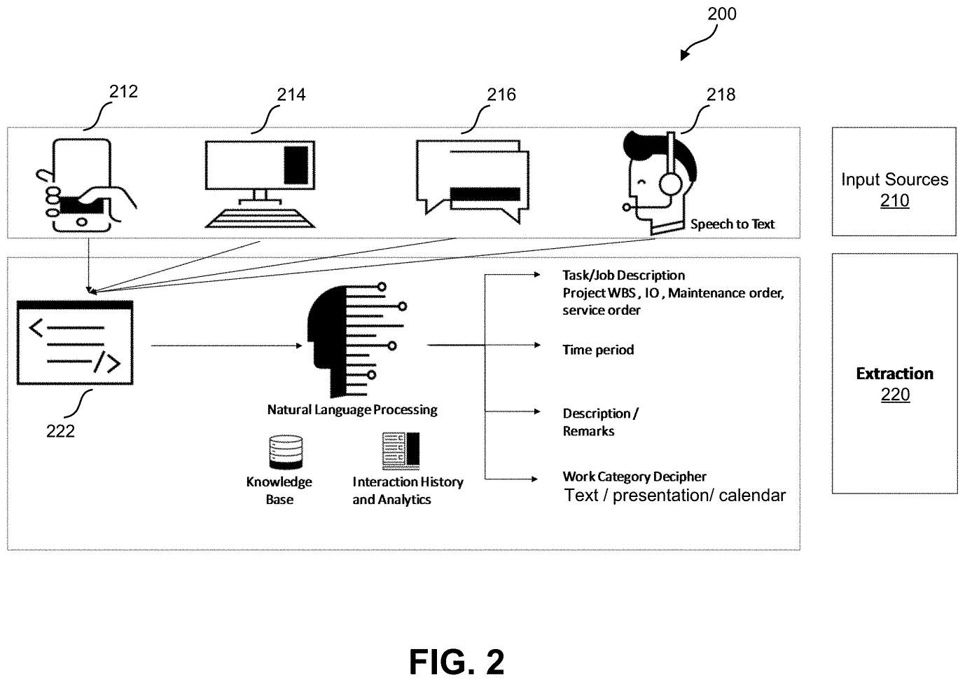

FIG. 2 is a block diagram 200 illustrating components of an intelligent timesheet. A timesheet can be generated based on timesheet data provided by one or more input sources 210. A user can populate and/or generate a timesheet by, for example, speaking or tactilely entering information into an application. The application can portray messages generated by a machine learning model. Timesheet data, for example, can include, but is not limited to, a time duration (e.g., days, hours, minutes, seconds) spent working on a particular task. In one example, a user can interact with a machine learning model via a graphical user interface displayed on an electronic device 212. Electronic device 212 can be a handheld electronic device such as a cellular telephone or a tablet. The one or more input sources 210 can also include a computer 214 (e.g., a laptop or desktop computer). Interaction with the one or more input sources 210 can include tactile input (e.g., via touching the input source 210 such as a touch sensitive display) and/or verbal input (e.g., via speaking through a microphone built within or coupled to input source 210). The interaction can include using an application or program that facilitates receipt of timesheet data. A user can also provide timesheet data via interactive messaging 216 on either electronic device 212 or computer 214. The interactive messaging 216 can be internet based messaging through a messaging application or internet webpage. Interactive messaging 216 can also include Short Message Service (SMS) and/or Multimedia Messaging Service (MMS) messaging. In yet another example, a user can also provide timesheet data via a speech-to-text interface 218 such as microphone coupled to or built within electronic device 212 or computer 214.

Information collected from the one or more input sources 210 can make up the timesheet data 222. Based on the data format of the input information provided by input sources 210, NLP and/or speech recognition can be performed on the timesheet data 222 to perform various extraction 220 in order to extract various time elements and a time duration from the provided input data. Further details on the extraction processing can be found in the descriptions for FIGS. 4-6. A time period or time duration can reflect the amount of time the user spent on a given task. The time elements, for example, can include a task and/or job description such as a project work-breakdown structure (WBS), an internal order (IO), a maintenance order, and/or a service order. Time elements can also include a description or remarks associated with the task such as a qualitative description of the task (e.g., “I enjoyed working on this task,” “the task was challenging due to lack of resources,” “I could be more efficient on this task in the future if I had a particular resource”). Time elements can also include a work category decipher which can provide external information relevant to the task performed by the user that may not be directly tied to a timesheet. For example, the work category decipher can include a text document (e.g., having a description of the task or instructions on how to complete the task), a presentation document (e.g., a document containing information related to the task), and/or a calendar (e.g., containing meeting related information which could quantify collaboration time associated with the task).

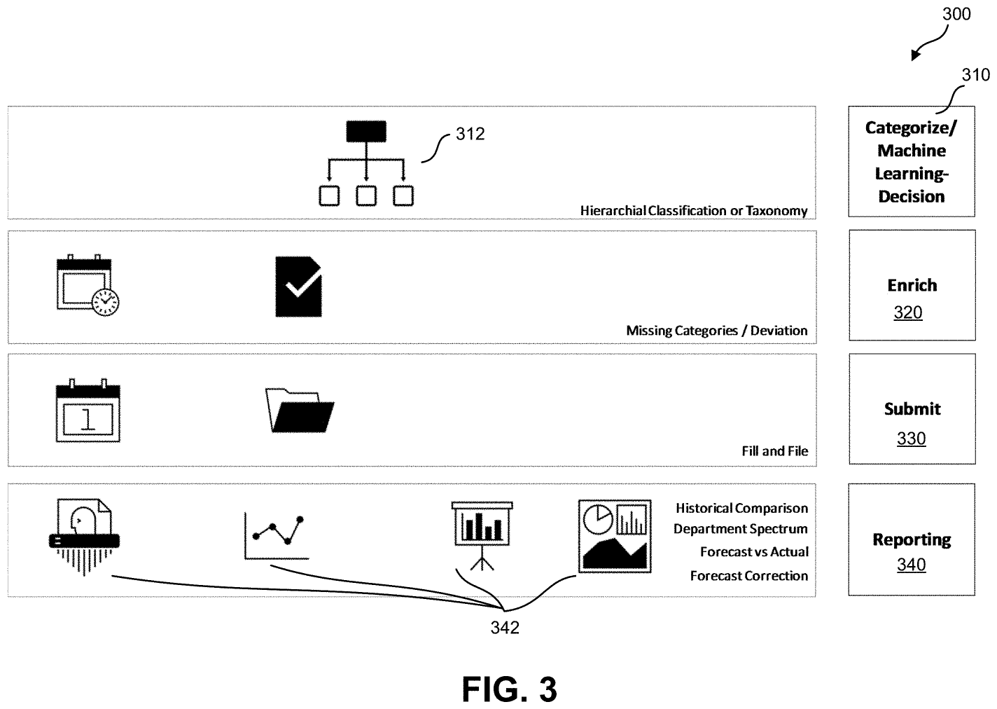

FIG. 3 is another block diagram 300 illustrating an intelligent timesheet. Continuing from FIG. 2, the extracted time elements can be categorized based on machine learning decisions into a hierarchical classification or taxonomy 312. In one example, the hierarchical classification or taxonomy 312 can be a sentiment analysis classification reflecting an emotion corresponding with a particular time entry (e.g., positive, neutral, or negative). For example, a description of “I enjoyed this task” could be classified as a positive sentiment. A description of “I neither enjoyed nor disliked this task” could be classified as a neutral sentiment. A description of “I disliked this task” could be classified as a negative sentiment. This example sentiment analysis provides a qualitative aspect to the timesheet. In another example hierarchical classification, time elements can be classified based on a category of work associated with the task such as analysis, development, testing, marketing, meetings, user interface and design, or other.

With some hierarchical classifications, each time element may not have a corresponding category. In these cases, an enrichment 320 can occur to generate one or more new categories. A natural language processor, for example, can identify and/or generate the one or more new categories. In some variations, the one or more new categories can be presented to an administrator via a graphical user interface (or application) for approval prior to creation. Once categorized, the timesheet data can be submitted, at 330, or stored in one or more databases such as an in-memory database or an externally coupled database.

With the timesheet data, a series of reporting 340 can occur to generate one or more reports 342. For example, a report can be automatically generated for organization object wide hours against the hierarchical classification categories. Reporting can, for example, facilitate data to answer questions such as how many hours are spent doing training or how many hours are spent doing development. Additionally, the reports can be a yearend report such as an employee review document. The one or more reports 342 can include a historical comparison between the current timesheet data and historical data stored in a database, a department spectrum identifying the various departments the tasks belong to, a forecast of tasks versus actual tasks, and/or a forecast correction based on completed tasks. With sentiment analysis, the reports can also identify qualitative information pertaining to the tasks such as what percentage of employees are satisfied or dissatisfied with the tasks.

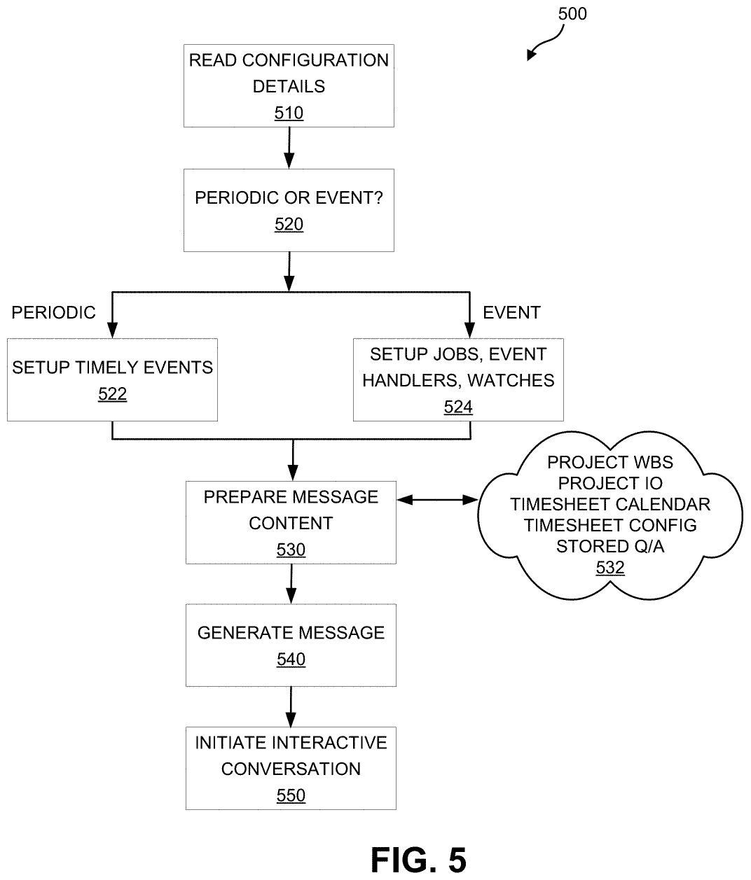

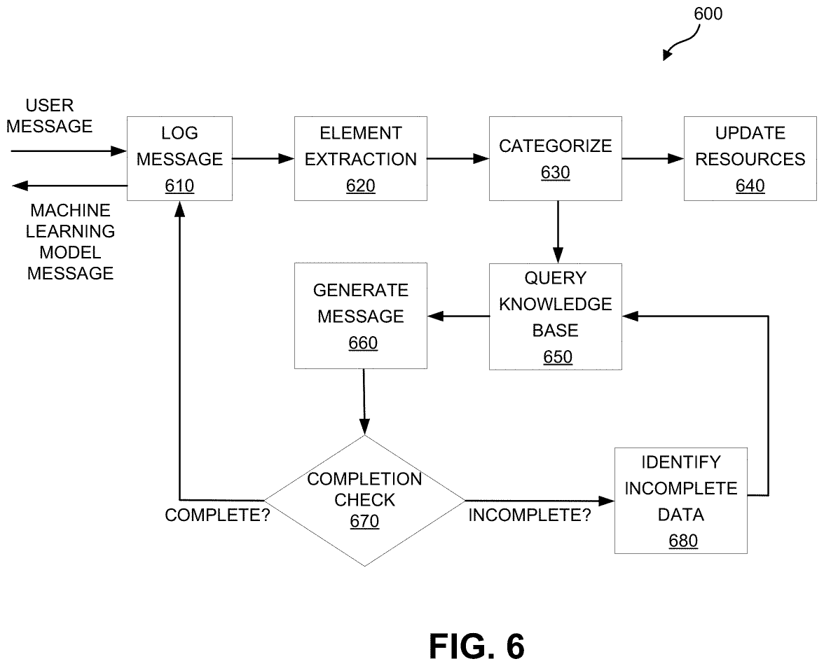

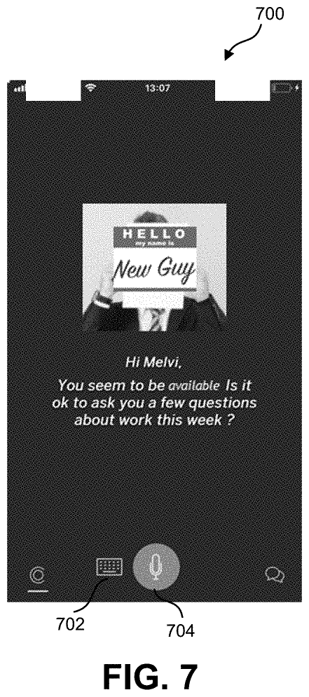

FIG. 4 illustrates an example flowchart 400 depicting data processing associated with the intelligent timesheet. A series of pre-process operations 500 can occur prior to an interactive message conversation, as described in more detail in FIG. 5. A user 420 (e.g., an employee and/or manager) and a machine learning model 430 can interact together via an interactive message conversation. For example, machine learning model 430 can generate a message that requests information from user 420 and user 420 can generate a message in response. Similarly, in another example, user 420 can request information from machine learning model 430 and machine learning model 430 can respond accordingly. Example interactive message conversations are described in more detail in FIGS. 7-12. Interactive message conversations can end either via action by the user 420 and/or action by the machine learning model 430. Throughout the interactive message conversation, machine learning model 430 can perform various execution operations 600 to analyze the message from the user 420 and generate an appropriate message in response, as described detail in FIG. 6.

FIG. 5 illustrates example flowchart depicting the pre-process operations 500 of FIG. 4. During pre-process operations 500, prior to an interactive message conversation between user 420 and machine learning model 430, configuration details pertaining to a particular user message are read at 510. Machine learning model 430 determines whether the message is either periodic or a discrete event at 520. If the message is periodic, timely reminders are established, at 522. A periodic message, for example, may be one that occurs at a predetermined frequency such as daily, weekly, monthly, and/or yearly. If the message is event driven, jobs, event handlers, and/or event watches can be established, at 524 to generate a message at an appropriate time. Event based messages might occur, for example, upon task completion, upon creation of a new task, or upon notice of an employee terminating employment. Either periodic or event based, once a message is triggered, the message content can be prepared, at 530. Machine learning model 530 can utilize knowledge base 532 to determine the context for a particular interactive message conversation. Knowledge base 532 can be made up of various information sources including, but not limited to, project WBS', project IOs, timesheet calendars, timesheet configurations, and/or pre-stored questions and answers (Q/A). Based on the prepared message content, a message can be generated at 540. An interactive conversation can be initiated, at 550, with the generated message.

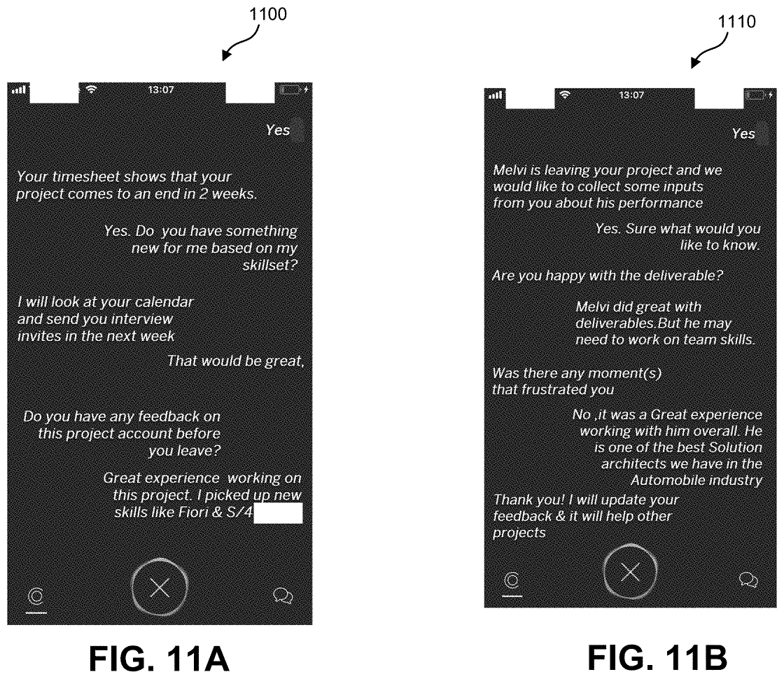

FIG. 6 illustrates an example process flow of execution operations 600. When user 420 submits a message such as an inquiry or provides a response to a previous machine learning model 430 message, the message is logged, at 610. Various time elements, such as keywords, are extracted from the message provided by user 420, at 620. The time elements are categorized, at 630, as previously discussed in FIG. 3. In some variations, the message can be provided to various resources to update the resources, at 640. For example, based on the time elements, updates can be made to a timesheet, calendar, or a report such as one having sentiment analysis. Additionally, based on the extracted time elements, a new interactive message conversation can be triggered to occur with another user, different from the initial user 420 as discussed in more detail in FIG. 11A-11B. For example, if an employee was the user 420 that participated in an initial conversation, then the employee's manager may be the “other user” and vice versa. Once the extracted time elements are categorized, the knowledge base 532 can be queried, at 650, to determine an appropriate message to provide to user 420, or in some cases to another user different from the initial user 420. A message can be generated, at 660, with the information queried from the knowledge base 532. The generated message can be checked for completeness, at 670. The completeness check can include comparing the generated message with the configuration details for the particular interactive message conversation. For example, the configuration details can specify the types of qualitative and/or quantitative information to be gained during a particular conversation. If the completion check 670 indicates the message is complete, the message can be logged, at 610 and provided to the user (e.g., machine learning model message of FIG. 6). If the completion check 670 indicates the message is incomplete, the incomplete data can be identified, at 680. The knowledge base 532 can be queried once again, at 650, to reconcile the incompleteness and the message generation can continue as previously described.

FIG. 7 illustrates an example message 700 via a user application for obtaining timesheet data from a user 420. A user 420 can be prompted for feedback relating to tasks corresponding to his or her timesheet. For example, FIG. 7 illustrates a message 700 via interactive messaging 216. Message 700 can be displayed on either electronic device 212 or computer 214. The message can be triggered based on an indication of a task completion (such as a completed WBS item of a project or an administrator marking the task as completed). A message can be triggered based on correlation of a work category decipher and the provided timesheet data (such as correlating a user's office calendar with time entered). In one example, message 700 relates to a new employee situation. Based on the employee's timesheet charging time to an induction program (e.g., via a WBS time element), it can be identified that the employee is new to the company. The message 700 can facilitate an interactive exchange with the employee to, for example, send the employee a list of project proposals or interview proposals and follow-up requests. The employee can interact with the message 700 via tactile inputs using, for example, a virtual keyboard 702. The employee can also interact with message 700 using verbal inputs via a microphone 704.

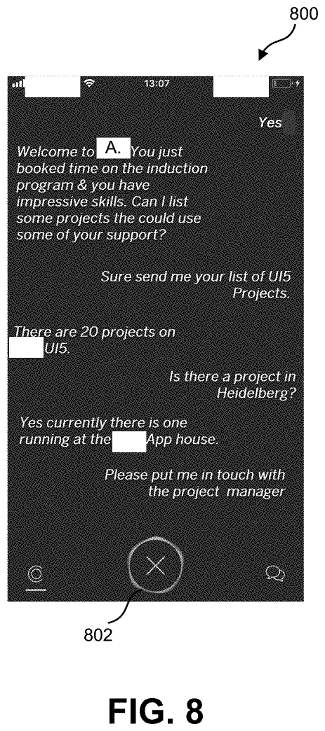

FIG. 8 illustrates an example interactive message conversation 800 between the employee and an automated message response. The response messages provided to the employee within interactive message conversation 800 can be predetermined messages stored in a database. The predetermined messages can be selected based on keywords within the employees messages. For example, the employee stating “Sure send me your list of UI5 Projects” can include keywords such as “list” and “UI5 Projects” that prompt the application to trigger pulling a list from a stored database (such as an in-memory database or an externally couple database). In another example within interactive message conversation 800, the employee can ask about particular projects in various geographical locations such as Heidelberg. The employee can exit the application at any time during the conversation using exit button 802.

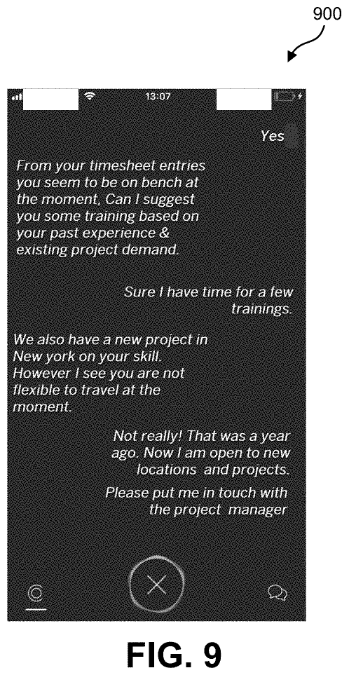

FIG. 9 illustrates another example interactive message conversation 900 between the employee and an automated message response. Interactive message conversation 900 can be with an employee who is awaiting work. For example, based on the employee's timesheet data provided, it can be identified that the employee is “on bench” or working on non-substantive tasks (e.g., overhead tasks). Through the interactive message conversation 900, the employees can be enlisted in upcoming trainings. The trainings, for example, can be identified by an application by cross-referencing a calendar source or other listing of upcoming training sessions. Additionally, through interactive message conversation 900 a relocation option can be offered to the employee based on availability of projects in the current location of the employee. In some variations, the current location can be determined by geographical positioning system data equipped on the handheld electronic device 212 or computer 214 used to interact with the employee. In other variations, the current location of the employee can be based upon human resource data stored in a database such as an in-memory database or an external databased coupled to the electronic device 212 or computer 214.

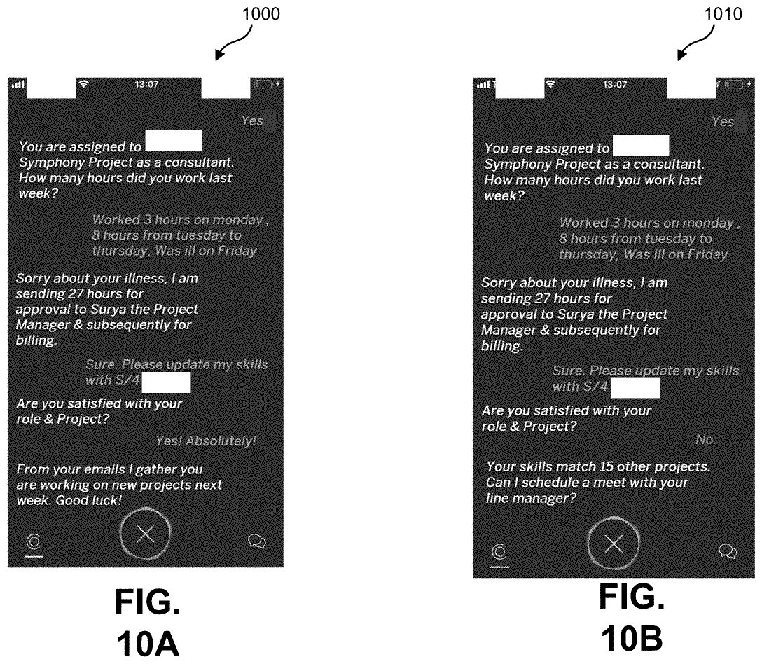

FIG. 10A illustrates another example interactive message conversation 1000 between the employee and an automated message response gathering qualitative information such as sentiments. Interactive message conversation 1000 can collect quantitative and/or qualitative data about the tasks completed by the employee. For example, as described in FIGS. 2-3, the employee can provide timesheet data input such as the amount of hours worked. An indication, by the employee, of being ill can be categorized as sick leave and reflected accordingly on the employee's generated timesheet. Interactive message conversation 1000 can also collect information regarding the employee's sentiment associated with the tasks completed. For example, the interactive message conversation 1000 can request feedback from the employee based on whether he or she is satisfied with his or her role and the project. The employee's response, such as “Yes! Absolutely!” can be categorized to reflect a satisfied employee as discussed previously in FIG. 3. Based on the employee's response being categorized as satisfied, the interactive message conversation 1000 can conclude with positive encouragement such as “Good luck!” In another variation to interactive message conversation 1000, FIG. 10B illustrates another example interactive message conversation 1010 between the employee and an automated message response. When asked about his or her satisfaction about the role and project, the employee in interactive message conversation 1010 indicates a negative satisfaction. Based on the negative response, the employee can be presented with varying project alternatives that match the employee's skills stored in a database such as an in-memory database or an external database coupled to handheld electronic device 212 or computer 214. In this example, interactive message conversation 1010 can assist the employee with scheduling a meeting with a resource manager based on the qualitative feedback solicited from the employee.

FIG. 11A illustrates another example interactive message conversation 1100 between the employee and an automated message response. Interactive message conversation 1100 can collect information from an employee when a project is coming to an end. For example, based on the employee's timesheet it can be determined that a project is coming to an end. Stored data pertaining to upcoming staffing needs or requirements, new staffing opportunities that match the employee's skillsets can be identified. Work category deciphers such as a calendar can be used to match the employee's availability based on calendar entries with interview times for identified staffing opportunities. Additionally, during the interactive message conversation 1100, qualitative feedback can be solicited and collected from the employee. In addition to receiving employee feedback through interactive message conversation 1100, a manager of the employee can also interact with an application to evaluate the employee's performance prior to him or her leaving the project. For example, FIG. 11B illustrates an example follow-up conversation 1110 between the employee's manager and response machine learning model based upon the interactive message conversation of FIG. 11A. Based on keywords in the manager's response during the interactive message conversation 1110, qualitative information can be categorized and stored as described in FIGS. 2-3.

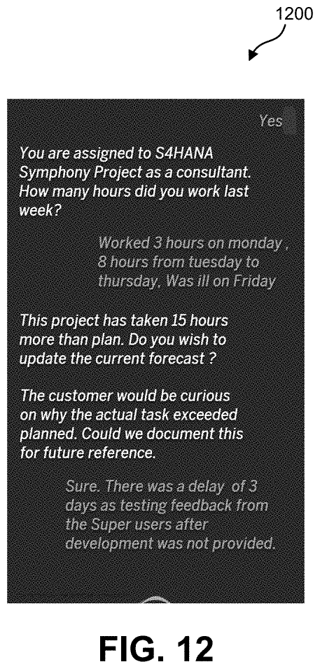

FIG. 12 illustrates another example interactive message conversation 1200 between the employee and an automated message response. In interactive message conversation 1200, the employee is questioned on a time duration spent on a particular task. Based on the employee's response, the employee can be questioned to provide additional qualitative information when the time duration exceeds, for example, a forecast projected for that particular task. The qualitative information can be extracted from interactive message conversation 1200 to update, for example, project management documents or task forecasts.

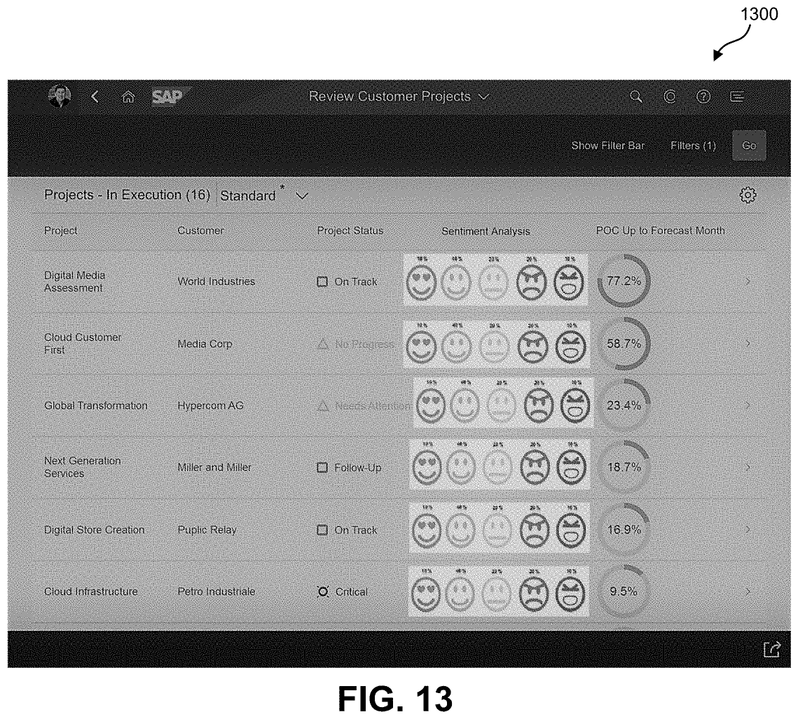

FIG. 13 illustrates an example report 1300 which can be a variation of report 342. Report 1300 can include qualitative and/or quantitative information based on the various time elements extracted from the interactive message conversation(s) described in FIGS. 7-12. For example, report 1300 can categorize various projects based on schedule, budget, resources, risks and issues, and/or quality metrics including qualitative and/or quantitative information. Report 1300 can roll up data from an employee level up to an organization level, along with any intermediary level there between. The roll up of the report 1300 can be a continuously generated and/or updated report based on periodic interactive message conversations with the employees and/or managers throughout a project timeline. As illustrated in FIG. 13, the report 1300 can include a qualitative sentiment analysis corresponding to the categorized time elements.

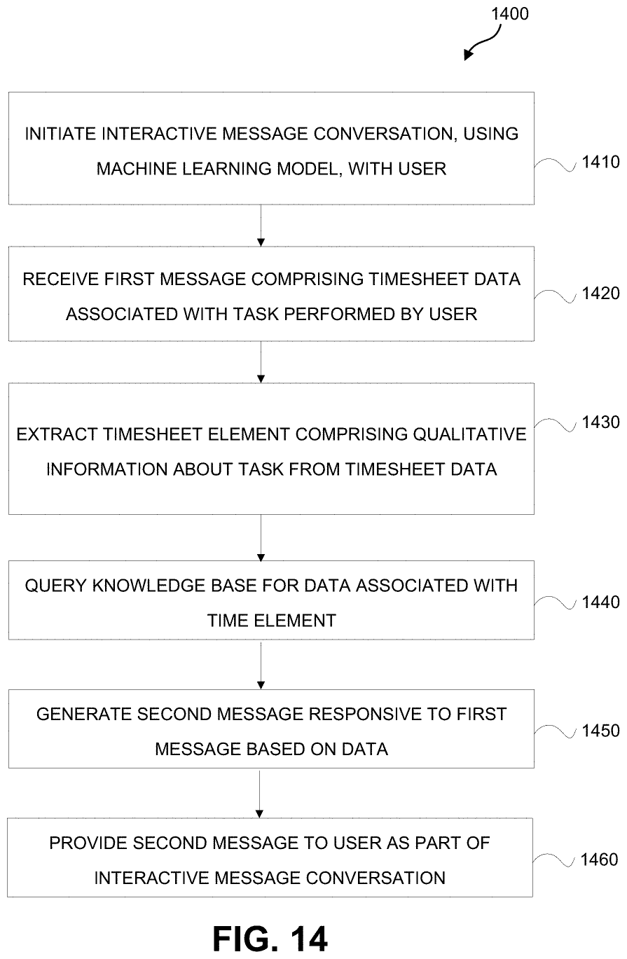

FIG. 14 is a process flow diagram 1400 illustrating an intelligent timesheet. An interactive message conversation is initiated, at 1410, with a user. A first message of the interactive message conversation is received, at 1420. The first message including timesheet data associated with a task performed by the user. A time element having qualitative information about the task from the timesheet data is extracted, at 1430. A knowledge base is queried, at 1440, for data associated with the time element. A second message responsive to the first message is generated, at 1450, based on the data. The second message is provided, at 1460, to the user as part of the interactive message conversation.

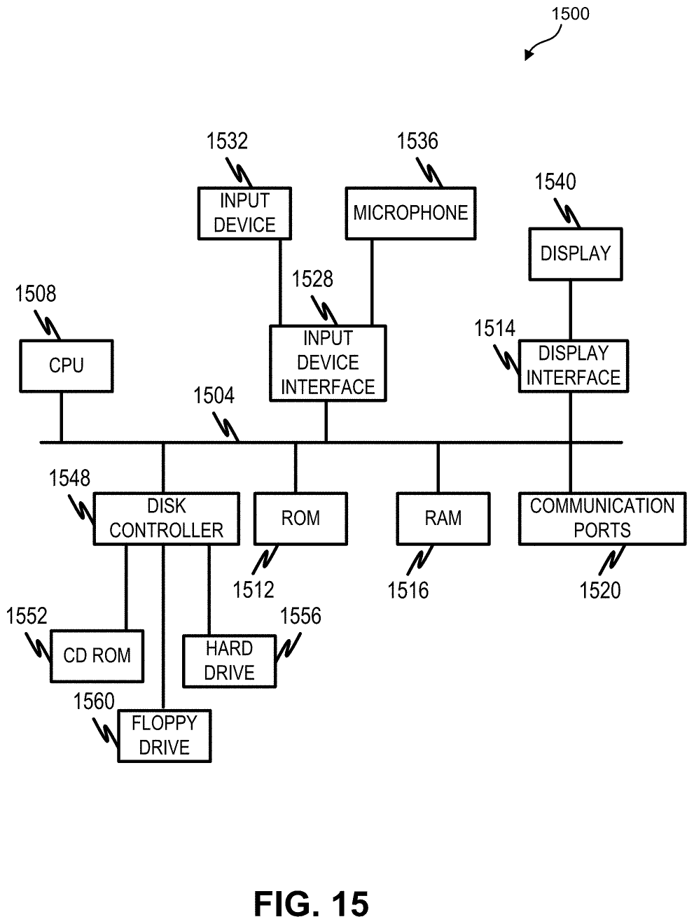

FIG. 15 is a diagram 1500 illustrating a sample computing device architecture for implementing various aspects described herein. A bus 1504 can serve as the information highway interconnecting the other illustrated components of the hardware. A processing system 1508 labeled CPU (central processing unit) (e.g., one or more computer processors/data processors at a given computer or at multiple computers), can perform calculations and logic operations required to execute a program. A non-transitory processor-readable storage medium, such as read only memory (ROM) 1512 and random access memory (RAM) 1516, can be in communication with the processing system 1508 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 1548 can interface one or more optional disk drives to the system bus 1504. These disk drives can be external or internal floppy disk drives such as 1560, external or internal CD-ROM, CD-R, CD-RW or DVD, or solid state drives such as 1552, or external or internal hard drives 1556. As indicated previously, these various disk drives 1552, 1556, 1560 and disk controllers are optional devices. The system bus 1504 can also include at least one communication port 1720 to allow for communication with external devices either physically connected to the computing system or available externally through a wired or wireless network. In some cases, the communication port 1520 includes or otherwise comprises a network interface.

To provide for interaction with a user, the subject matter described herein can be implemented on a computing device having a display device 1540 (e.g., a CRT (cathode ray tube) or LCD (liquid crystal display) monitor) for displaying information obtained from the bus 1504 to the user and an input device 1532 such as keyboard and/or a pointing device (e.g., a mouse or a trackball) and/or a touchscreen by which the user can provide input to the computer. Other kinds of input devices 1532 can be used to provide for interaction with a user as well; for example, feedback provided to the user can be any form of sensory feedback (e.g., visual feedback, auditory feedback by way of a microphone 1536, or tactile feedback); and input from the user can be received in any form, including acoustic, speech, or tactile input. In the input device 1532 and the microphone 1536 can be coupled to and convey information via the bus 1504 by way of an input device interface 1528. Other computing devices, such as dedicated servers, can omit one or more of the display 1540 and display interface 1514, the input device 1532, the microphone 1536, and input device interface 1528.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) and/or a touch screen by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
initiating, by at least one data processor of a computing device using a machine learning model, an interactive message conversation with a user;
receiving, by at least one data processor, a first message of the interactive message conversation comprising timesheet data associated with a task performed by the user;
extracting, by at least one data processor, a time element comprising qualitative information about the task from the timesheet data;
querying, by at least one data processor, a knowledge base for data associated with the time element;
generating, by at least one data processor, a second message responsive to the first message based on the data responsive to the query; and
providing, by at least one data processor, the second message to the user as part of the interactive message conversation.

2. The computer-implemented method of claim 1, further comprising identifying, by at least one data processor, a category corresponding to the time element.

3. The computer-implemented method of claim 2, further comprising. generating, by at least one data processor, at least one of a timesheet with the extracted time element or a report with identified category.

4. The computer-implemented method of claim 1, wherein the interactive message conversation is initiated by the user.

5. The computer-implemented method of claim 1, wherein the interactive message conversation is initiated by the machine learning model based on a periodic-based message at a predetermined frequency.

6. The computer-implemented method of claim 1, wherein the interactive message conversation is initiated by the machine learning model based on an event-based message triggered by at least one of user availability determined by a calendar of the user, a termination of the task, or a time duration of the task, or termination of efforts of the user on the task.

7. The computer-implemented method of claim 1, further comprising correlating the timesheet data with an external data source, wherein the external data source comprises at least one of a calendar application, a text document, or a database.

8. The computer-implemented method of claim 7, wherein the database is an in-memory database.

9. The computer-implemented method of claim 1, wherein the knowledge base comprises at least one of a project work-breakdown structure (WBS), a maintenance order, an internal order, a service order, a timesheet calendar, a timesheet configuration, or predetermined questions and answers.

10. The computer-implemented method of claim 1, wherein the timesheet data is provided via input to an application displayed on an electronic device.

11. The computer-implemented method of claim 10, wherein the input comprises at least one of verbal input or textual input.

12. The computer-implemented method of claim 3, further comprising generating, based on the absence of an identified category, a new category corresponding to an unidentified time element.

13. The computer-implemented method of claim 1, further comprising generating, by at least one data processor, a report comprising sentiment analysis based on the qualitative information.

14. The computer-implemented method of claim 1, wherein the extracting is performed using at least one of natural language processing or speech recognition.

15. The computer-implemented method of claim 1, wherein the time element further comprises quantitative information.

16. The computer-implemented method of claim 1, further comprising comparing content of the second message with a message configuration identifying required qualitative and/or quantitative information to confirm that the content is complete.

17. The computer-implemented method of claim 16, further comprising generating, based on an incomplete second message, a third message based on a second query of the knowledge base.

18. A system comprising:
at least one data processor;
physical disk storage; and
memory storing instructions which, when executed by the at least one data processor, result in operations comprising:
initiating, by at least one data processor of a computing device using a machine learning model, an interactive message conversation with a user;
receiving, by at least one data processor, a first message of the interactive message conversation comprising timesheet data associated with a task performed by the user;
extracting, using natural processing or speech recognition, by at least one data processor, a time element comprising qualitative information about the task from the timesheet data;
querying, by at least one data processor, a knowledge base for data associated with the time element;
generating, by at least one data processor, a second message responsive to the first message based on the data; and
providing, by at least one data processor, the second message to the user as part of the interactive message conversation.

19. The system of claim 18, wherein an in-memory database comprises the memory storing instructions.

20. A non-transitory computer-programmable product including storing instructions which, when executed by at least one data processor forming part of at least one computing system, result in operations comprising:
initiating, by at least one data processor of a computing device using a machine learning model, an interactive message conversation with a user;
receiving, by at least one data processor, a first message of the interactive message conversation comprising timesheet data associated with a task performed by the user;
extracting, using natural language processing or speech recognition, by at least one data processor, a time element comprising qualitative information about the task from the timesheet data;
querying, by at least one data processor, a knowledge base for data associated with the time element;
generating, by at least one data processor, a second message responsive to the first message based on the data; and
providing, by at least one data processor, the second message to the user as part of the interactive message conversation.
